(19) United States
(12) Patent Application Publication
(10) Pub. No.: US 2016/0026201 A1
(43) Pub. Date: Jan. 28, 2016

(54) SYSTEMS AND METHODS FOR CONTROLLING ELECTRICAL DEVICES

(71) Applicants: Mohan Vellanki, Waltham, MA (US); Siddharth Singh, Waltham, MA (US); Phaneendra Varma Siravuri, Waltham, MA (US)

(72) Inventors: Mohan Vellanki, Waltham, MA (US); Siddharth Singh, Waltham, MA (US); Phaneendra Varma Siravuri, Waltham, MA (US)

(21) Appl. No.: 14/340,092

(22) Filed: Jul. 24, 2014

(51) Int. Cl. G05F 1/66; H04L 29/08; H04W 4/00; G05B 15/02

(52) U.S. Cl. CPC G05F 1/66; G05B 15/02; H04L 67/10; H04W 4/005

(57) ABSTRACT

A wireless switch control panel may control supply of current to a plurality of outlets. Control may be exercised to adjust current levels and may be for standard AC voltages including 110 VAC and 220 VAC. A system including such a wireless switch panel may include a hub which coordinates communication among components including one or more wireless switch panels, optional sensors, and wireless electronic devices such as smartphones or tablets.

### CROSS-REFERENCE TO RELATED APPLICATIONS

This application claims priority under 35 U.S.C. §119 to U.S. provisional application entitled SYSTEMS AND METHODS FOR CONTROLLING ELECTRICAL DEVICES, U.S. Ser. No. 61/858,691, filed on Jul. 26, 2013, the disclosure of each of which is hereby incorporated by reference in its entirety.

### TECHNICAL FIELD

Inventive concepts generally relate to building automation systems, and, in particular, to one or more devices that wirelessly control electrical distribution in a building.

### BACKGROUND

Electricity is typically received at a building from a power line at a breaker panel or, in older buildings, at a fuse panel. From the breaker panel, wires are distributed throughout the structure to supply electricity to devices, referred to herein as outlets. By the term outlet, we mean any facility for supplying electricity to an electrical component. This may include wall sockets into which devices such as computers, televisions, fans, etc. may be plugged, may include light sockets into which bulbs may be screwed, or may include junction boxes, or the like, into which components such as furnace motors, heater coils, or air conditioning compressors may be permanently wired and through which they receive electrical power for operation.

Typically power to the outlet (that is, wall socket, light socket, junction box, for example) is controlled by manual operation of a switch, either on a wall (for a ceiling light socket, for example) or on an appliance (a coffee-maker, for example, that is plugged into a wall socket).

Advanced control of electrical devices such as these may provide benefits in efficiency and convenience.

### SUMMARY

Example embodiments in accordance with principles of inventive concepts include an electrical switching device, that includes a switching module including a plurality of switches for controlled connection between an electrical power source and a plurality of electrical outlets; and a wireless electrical node including a controller to wirelessly receive a command and to respond to the command by controlling the state of the plurality of switches.

Example embodiments in accordance with principles of inventive concepts include an electrical switching device wherein a wireless electrical node is connected to wirelessly provide switch status information.

Example embodiments in accordance with principles of inventive concepts include an electrical switching device including local input/output (I/O) for control and status of the plurality of switches.

Example embodiments in accordance with principles of inventive concepts include an electrical switching device including an interface for input from a sensor device.

Example embodiments in accordance with principles of inventive concepts include an electrical switching device wherein the local I/O includes a touchscreen input.

Example embodiments in accordance with principles of inventive concepts include an electrical switching device wherein the local I/O includes a graphical output display.

Example embodiments in accordance with principles of inventive concepts include an electrical switching device includes a wireless interface for receiving from and transmitting to a portable wireless device.

Example embodiments in accordance with principles of inventive concepts include an electrical switching device wherein the wireless interface is a WiFi interface.

Example embodiments in accordance with principles of inventive concepts include an electrical switching device wherein the wireless node is responsive to proximal presence of an individual by reporting such presence via a wireless interface.

Example embodiments in accordance with principles of inventive concepts include a wireless switching hub, including a wireless interface for communications with a wireless electrical switching device; a web interface for communications with the world wide web; and a controller responsive to commands received through the wireless interface by forwarding the commands to a wireless electrical switching device.

Example embodiments in accordance with principles of inventive concepts include a wireless switching hub wherein the controller is responsive to a status message from the wireless electrical switching device by updating a status database.

Example embodiments in accordance with principles of inventive concepts include a wireless switching hub, wherein the controller is responsive to a status message from the wireless electrical switching device by transmitting the updated status to devices other than the wireless electrical switching device from which it received the status update.

Example embodiments in accordance with principles of inventive concepts include a wireless switching hub, wherein the hub is configured to provide status and control access to the wireless electrical switching device to wireless electronic devices through the World Wide Web.

Example embodiments in accordance with principles of inventive concepts include a wireless switching hub, wherein the hub is configured to generate a token for secure communications with other devices.

Example embodiments in accordance with principles of inventive concepts include a wireless switching hub includes a push notification server to output the status of devices in communication with the hub.

Example embodiments in accordance with principles of inventive concepts include a wireless switch control system including, a wireless electrical switching device including a switching module including; a plurality of switches for controlled connection between an electrical power source and a plurality of electrical outlets, and a wireless electrical node including a controller to wirelessly receive a command and to respond to the command by controlling the state of the plurality of switches; and a wireless hub, including; a wireless interface for communications with a wireless electrical switching device, a web interface for communications with the world wide web, and a controller responsive to commands received through the wireless interface by forwarding the commands to a wireless electrical switching device.

Example embodiments in accordance with principles of inventive concepts include a wireless switch control system including a sensor configured to communicate with the wireless hub.

Example embodiments in accordance with principles of inventive concepts include a wireless switch control system including a sensor chosen from among the group of: fire sensor, smoke sensor, intrusion sensor, or video sensor.

Example embodiments in accordance with principles of inventive concepts include a wireless switch control system wherein a sensor is a video camera that is configured to send video information wirelessly to the hub and the hub is configured to forward the video information wirelessly.

Example embodiments in accordance with principles of inventive concepts include a wireless switch control system including, wherein the hub is configured to generate a token for communications among devices within the system.

### BRIEF DESCRIPTION OF THE DRAWINGS

The foregoing and other objects, features and advantages of embodiments of inventive concepts will be apparent from the description of example embodiments, as illustrated in the accompanying drawings in which like reference characters refer to the same elements throughout the different views. The drawings are not necessarily to scale, emphasis instead being placed upon illustrating the principles of the preferred embodiments.

FIG. 1 is a block diagram of an electrical distribution system including a wireless switch controller in accordance with principles of inventive concepts;

FIG. 2 is a block diagram of a wireless switch control system in accordance with principles of inventive concepts;

FIG. 3 is a block diagram of a wireless switch panel in accordance with principles of inventive concepts;

FIG. 4 is a block diagram of a wireless switch control system hub in accordance with principles of inventive concepts;

FIG. 5 is a flow diagram illustrating communications through a wireless switch control system in accordance with principles of inventive concepts; and

FIG. 6 is a flow chart illustrating the process of generating secure communications in a wireless switch control system in accordance with principles of inventive concepts.

### DETAILED DESCRIPTION

Various exemplary embodiments will be described more fully hereinafter with reference to the accompanying drawings, in which exemplary embodiments are shown. The inventive concepts may, however, be embodied in many different forms and should not be construed as limited to exemplary embodiments set forth herein.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items. The term “or” is used in an inclusive sense unless otherwise indicated.

It will be understood that, although the terms first, second, third, for example. may be used herein to describe various elements, components, and/or devices, these elements, components, and/or devices should not be limited by these terms. These terms are only used to distinguish one element, component, or device from another. In this manner, a first element, component, or device discussed below could be termed a second element, component, or device without departing from the teachings of inventive concepts.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. In this manner, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of exemplary embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, as examples, but do not preclude the presence or addition of one or more other features, integers, steps, operations, elements, components, and/or groups thereof.

Exemplary embodiments are described herein with reference to illustrations that are schematic illustrations of idealized exemplary embodiments (and intermediate structures). As such, variations from the shapes of the illustrations are to be expected. In this manner, exemplary embodiments should not be construed as limited to the particular shapes illustrated herein, but are to include deviations in shapes.

Processes may be described as including steps that proceed in a certain order, but inventive concepts are not limited thereto, unless indicated. Other sequences of steps, substitution or deletion of steps, or other processes are contemplated within the scope of inventive concepts.

Unless otherwise defined, all terms (including technical and scientific terms) used herein have the same meaning as commonly understood by one of ordinary skill in the art to which exemplary embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

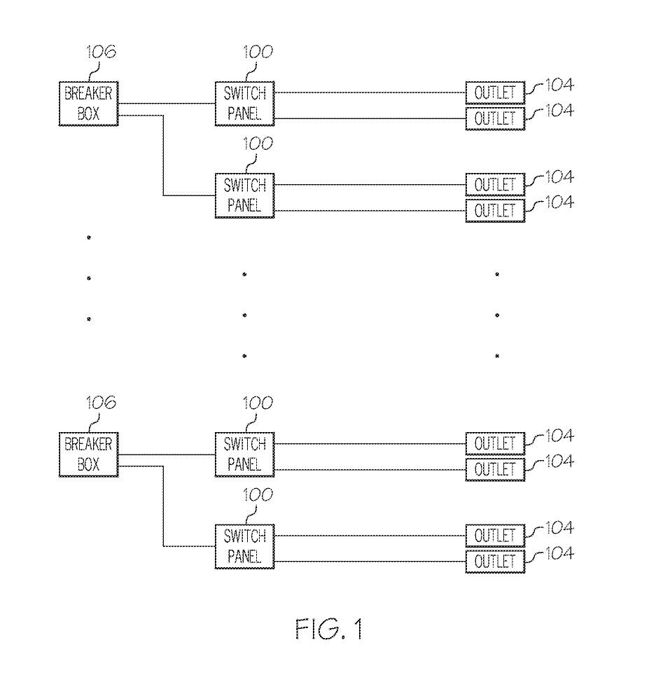

The block diagram of FIG. 1 illustrates an electrical distribution system 102 for a building which may employ at least one wireless electrical switch panel 100 in accordance with principles of inventive concepts. In this example embodiment the building includes a plurality of breaker boxes 106. Each breaker box 106 may be associated with a unit within a larger building: and office within and office building, a condominium within a condominium building, a shop within a retail outlet, a section of an airport, any partition of a building that received electrical power, for example. Although a single family dwelling will typically include only one breaker box 106, embodiments including a plurality of breaker boxes 106 are contemplated within the scope of inventive concepts.

“Line power,” that is, power from the electric utility, may be received at a breaker box 106 and distributed through wiring throughout a building. In larger buildings, a hierarchical system of breaker boxes may distribute electricity throughout the building to individual units having their own breaker boxes. Breaker boxes 106 provide load-protection for wiring, devices attached to the wiring, and for the building housing the breaker box. If, for example, a device connected to an electrical circuit draws excessive current, a breaker within the box 106 associated with the circuit supplying electricity to the device will open, thereby cutting off current to the device and preventing fire or other damage.

Within each unit U (or within each single family dwelling, for example) one or more wireless electrical switch panels 100 in accordance with principles of inventive concepts may be wired into a circuit emanating from a breaker box 106. As will be described in greater detail below, each wireless switch panel 100 may control a plurality of circuits terminated in an electrical outlet 104. Again, by electrical outlet, we are referring to a wall outlet, a light socket, or a junction box supplying electrical power to a hardwired appliance, such as a furnace fan, or water heater, for example.

Each wireless switch panel 100 may include, in addition to a wireless interface, any of a variety of input/output interfaces, such as touch, keypad, voice, or proximity input or graphic display, indicator light, or audio output, for example. A wireless switch panel 100 may include actuators for controlling a plurality of switches associated with the switch panel 100. Such actuators may include a solenoid for opening or closing a switch to thereby supply power to, or cut off power from, an outlet 104. Additionally, one or more variable control devices, such as a rheostat, transformer, or triode alternating current switch (triac) may be included to not only supply electrical power, but to control the amount of electrical power supplied to an outlet 104 in order to, for example, dim a light, turn down a fireplace, or set a thermostat, for example. In example embodiments switch panel 100 may be flush mounted in a wall, for example, in the same room as outlets under its control. That is, switch panel 100 may be permanently wired into a building, flush-mounted into a wall, with power supplied to it from breaker box 106. In such an example embodiment, switch panel 100 may control power delivered to a plurality of outlets 104 which may be relatively remote from switch panel 100, with switch panel 100 positioned at waist level on a wall and outlet 104 a light socket in the ceiling, for example.

In example embodiments, switch panel 100 may control one or more electrical appliances, including light-illuminating apparatuses such as lamps, appliances, audio and video zones, window blinds, entertainment, media systems, security systems, and/or any electrical devices connected to an electrical outlet at a home, business, or other structure constructed and arranged to receive electricity from an electric power line. Switch panel 100 may switch, dim, or otherwise control the electrical devices at a predetermined voltage level, for example, 110 v or 220 v AC. In other embodiments, switch panel 100 may switch, dim, or otherwise control the electrical devices at voltages less than a local regulated level, for example, less than 110 v AC or 220 v AC. Switch panel 100 may be constructed and arranged for positioning in a wall, for example, concealed in a wall or inserted into an opening in a wall and flush with the wall. Switch panel 100 be controlled remotely, for example, via a smartphone or tablet or web-accessible computer, or controlled manually with a local I/O interface.

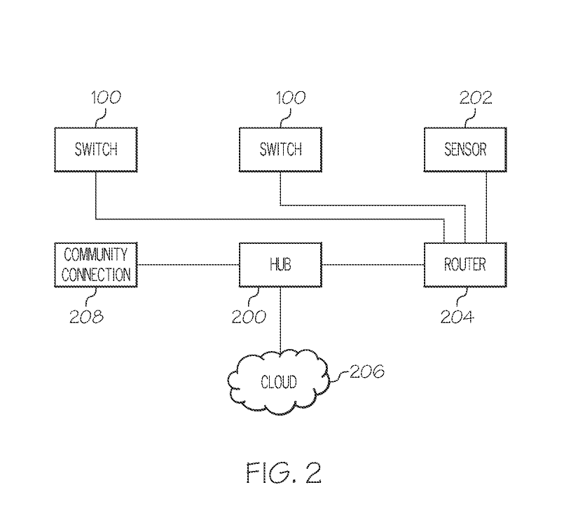

An example embodiment of a system 203 in accordance with principles of inventive concepts is depicted in the block diagram of FIG. 2. In this example embodiment, which may be an embodiment in a single family dwelling, an office within an office building, or a condominium within a multi-unit building, for example, a hub 200 (also referred to herein as a smarthub) in accordance with principles of inventive concepts provides central access, control, and monitoring of switch panel(s) 100 and sensors 202. A wireless router 204 provides wireless communications to devices within system 203. Hub 200 provides access, through wired or wireless communications link 201 to “cloud” 206, which may include, for example, Internet access. A community connections server 208 may be employed in a multi-unit building to provide communications among a plurality of hub-centered systems, each within a different unit of a multi-unit building, for example. Switch panels 100, hub 200, and sensors 202 are described in greater detail greater detail below. The cloud can include a wide area network, local area network, wireless network, or a combination thereof, and can include switches, routers, and so on that permit data, voice, or other communications between different locations.

As described in the discussion related to FIG. 1, switch panels 100 provide physical control of connectivity between a power source, such as a breaker box 106 and outlets 104. Hub 200 transmits wireless commands to switch panels 100 to effect control, through switch panel 100 of outlets 104. Commands sent to a switch panel 100 by hub 200 may originate with a portable electronic device, such as a smartphone, tablet computer, laptop computer, or other remote entry device and may be received from cloud 206 by hub 200. A user may, for example, use his smartphone to enter a command to adjust the temperature of his house on his way home. The command may transmitted through a cellular service, through the cloud 206 and to hub 200. Hub then sends a wireless command, through router 204, to a switch panel 100 that controls an outlet 104 that controls operation of the home's HVAC system.

Hub 200 may coordinate the operation of all devices within a system in accordance with principles of inventive concepts, sending commands to devices, such as switch panels 100 and receiving messages from switch panels 100 and other devices such as sensors. Such messages may be status messages or alarms, for example and, hub 200 may store information related to such message in a database that it maintains, for example. Status information, such as the control state (for example, switch position) of switches controlled by a switch panel 100 may be stored by hub 200. Additionally, alarms, received from sensors, such as fire sensors, motion detectors, or intrusion detectors may be stored in the database and may be forwarded to the cloud 206 for messaging to officials, security contracting firms, or the individuals who own the dwelling, for example. Community connection server 208 may be used to link other hubs 200 within the same building or within the same complex of buildings, for example, allowing hubs 200 to share information and a centralized control facility to monitor power usage, air balancing, security, and other building functions, for example.

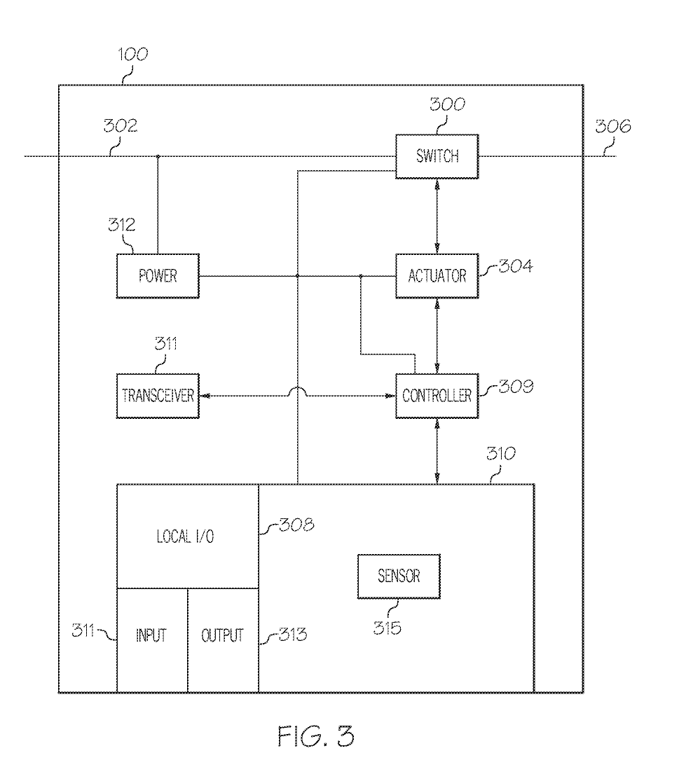

The block diagram of FIG.3 illustrates an example embodiment of a switch panel 100 in accordance with principles of inventive concepts. Switch module 300 receives electrical power through wires 302 from a breaker box 106 and, under control of actuators 304, connect to wires 306 which supply power to outlets 104. Actuators 304 may, in turn, be controlled by a wireless controller module 308 or local input/output (I/O) 310, which input may also be routed through wireless controller module 308. A power supply 312 supplies power to wireless controller 308, to local I/O 310, and to actuators 304.

In example embodiments, the switch module 300, wireless controller 308 module, local I/O 310, and sensor module 315 may be co-located within a single housing. In other example embodiments, one or more of these elements may be located apart from one another and may communicate with each other via a network connection such as one known to those of ordinary skill in the art, for example, a local area network or wide area network.

Actuators 304 may be any of a variety of electronically-controlled switching devices, such as a solenoid actuated switch, a rheostat, a transformer, or triac circuit, for example, and may operate with any of a variety of voltages, such as 110 AC, 220 AC, or other line voltage. Actuators may also control current supplied to outlets 104. Power supply 312 may be connected to input power (for example, wires 302) to derive power directly from a breaker box 106 and may include a regulator to provide power to wireless controller 308, local I/O 310 and actuators 304. Power supply 312 may include power storage, such as a battery back-up, to ensure operation of switch panel 100 in the event of a power failure, for example.

Wireless controller module 308 may include a wireless transceiver 311 suitable for operation with a local area wireless network such as an IEEE 802.11, system, also referred to herein as a WiFi system, for example. Wireless controller module 308 may communicate with other system components, such as hub 200 through transceiver 311, and with actuators 304 and local I/O module 310 through a parallel or serial interface such as a system bus, for example. In example embodiments wireless controller module 308 includes controller 309, which may be implemented using a microprocessor, microcontroller, digital signal processer, application specific integrated circuit or other technology, or a combination thereof.

Controller 309 may operate actuators 304 in response to commands and may provide status information related to switches controlled by actuators 304 or local I/O module 310 to other system components, in particular, hub 200. Controller 309 may also operate local I/O module 310, responding to input from input devices 311, such as keypad, touch pad, dial, proximity sensor, or other input devices and providing output to local I/O output 313, which may be a graphic display, status lights, such as LEDs, for example, video display or other display, for example. Controller 309 may also provide an interface for sensors which may be associated with switch panel 100. Such sensors may include smoke sensors, fire sensors, motion detectors, or intrusion detectors, for example.

A command to an actuator 304 may be a signal provided by a hardware pin connected between the controller 309 and a relay at the switch module 300, for example, a “high” signal of 3.3V. The commands may be received by the controller 309 from a remote tablet, the hub 200, a smartphone, or other electronic device, for example, described herein. In the case of a smartphone, tablet, or laptop, such a command may be conveyed through a cellular system to a wireless router 204 and from there, to hub 200 and on to controller 309, for example. A command may be included with a CONTROL_ENDPOINT message, for example, described herein. For example, the switch module 300 can switch and/or adjust an electrical current flowing at voltages of 230 v AC, or voltages greater than or less than 230 v AC, in response to a command from the controller 309.

The switch module 300 may include a regulator circuit that regulates the amount of current or an attribute of current such as the frequency of an alternating current (AC) flowing through the contacts of the switch module 300, and/or regulates other electricity-related features such as a RMS voltage at the contact points, for example, where the current or RMS voltage is variable. The amount of current and/or frequency enables an end user to control a variable motor or the like, for example, a ceiling fan, floor fan, or other appliance or electrical device that is impacted by a change in received current. The Wi-Fi transceiver 312 can communicate with a control user interface, for example, at the hub 200 or other control device on a network to relay control and status commands to the user interface.

WiFi module 314, may connect, directly, or through hub 200, to the community connection server 208 over a wireless network, to relay control and status commands to a user interface. For example, a REGISTER message can be used to register a Wi-Fi controlled electrical node, a tablet, and/or other endpoints with the hub 200 and/or the community connection server 208. An endpoint can be a sensor or a smart switch panel that communicates with an electrical device under control, for example, a ceiling fan. A Control_Endpoint control message may be used to activate/inactivate a switch, or relay, connected to an electrical node. Switch panel 100 can communicate using WPA2 encryption or the like, over well-known bandwidths such as 2.4 GHz and/or 5.0 GHz for controlling and monitoring a status of individual switches in communication with hub 200, for example.

In example embodiments, controller 309 may control the switches as follows. Each relay control pin is connected to an individual pin of the controller 309. The software program on the microcontroller can control the voltage levels on the pin between 0 v to 3.3 v. A Control_Endpoint message is received by the controller 309 which parses the message, validates the message source based on an authentication token, and identifies the relay pin it needs to control (ON/OFF). The corresponding pin voltage can transition between 0 v, i.e., an OFF state, or 3.3 v, i.e., an ON state by the software on the microcontroller, for example. This sequence can be performed in similar manner in embodiments where a touch device is used to control the relay.

Local I/O module 310 may include one or more sensors such as detection devices or the like such as a surveillance camera, photoelectric detector, passive infrared sensor, LPG leakage sensor, carbon dioxide sensor, intruder alert system, motion sensor, air monitor, panic alert, air quality sensor, or a combination thereof, for example. Such sensors may communicate with hub 200 and/or with switch panel 100. A motion or proximity sensor may, for example, indicate the presence of someone near a switch panel 100, for example, and the sensor may output a sensor alert event message to the hub 200. A user can configure one or more rules in the hub 200 to determine actions to take based on a received event. For example, a rule can be established to switch a particular node, for example, a switch, to an on state, upon receipt of the sensor alert event message. The hub 200 can parse the rule and send a Control Endpoint message to the specific switch panel, more specifically, a Wi-Fi controlled electrical node, which is an alternating current (AC) powered device that controls a power output to one or more electrical appliances in communication with the node, for example, a light.

In example embodiments in accordance with principles of inventive concepts, a user may create rules to implement different actions such as sending email, SMS text messages, the generation of signals for controlling lights, appliances, and/or other electrical devices, and so on. A user interface, which may be installed on a smartphone, a tablet computer, or a laptop computer, for example, may be configured to permit users to add, delete, or modify rules, and can be available at a tablet, smartphone, or other computer device, for example, via a web browser interface.

As described herein, embodiments of the switch panel 100 may be operated by a touch panel, for example, which may be constructed and arranged to generate command-related signals by a touch of a finger, a stylus, or other object when a force is applied to the touch panel. In example embodiments switch panel 100 may also be operated by a wireless control from a smartphone, tablet, laptop computer, or other electronic device using, for example, a web browser communicating with switch panel 100 through hub 200, for example.

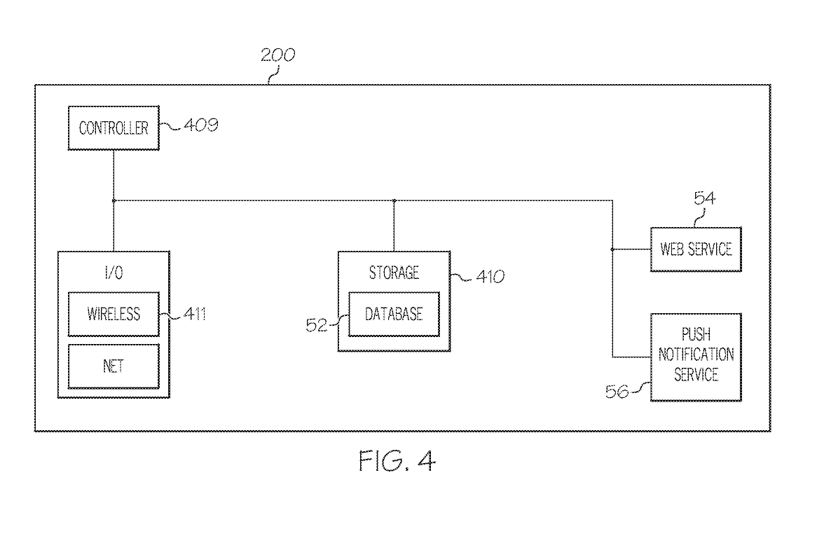

An example embodiment of a hub 200 in accordance with principles of inventive concepts is illustrated in the block diagram of FIG. 4. Hub 200 includes a wireless transceiver 411 a controller 409 and local storage 410. Wireless transceiver 411 may be capable of operating in a WiFi network, for example, and may be used to communicate with switch panels 100, sensors 202, community connection server 208, and router 204 for example. Hub 200 may also include communications module 412 for connection to cloud 206 through coaxial cable, twisted wire pair, optical fiber or other communications link. Controller 309 may employ storage 410 to maintain status information for all devices associated with system 203. Controller 309 may update status information on a timed basis or in response to activity within the system 203. In addition to alerting users, authorities, building management, or security personnel in response to sensor activity, such as the triggering of a smoke alarm, hub 200 may store data, such as time, date, sensor identity or other relevant data, for example.

The hub 200 wirelessly facilitates communication between and among various components of the system 102 such as one or more switch panels 100, separate display panels, sensors, such as fire sensors, motion detection sensors, security devices such as cameras, and so on and other elements of the system. The hub 200 allows remote control of electrical appliances via smartphone applications, a web account, or other remote device.

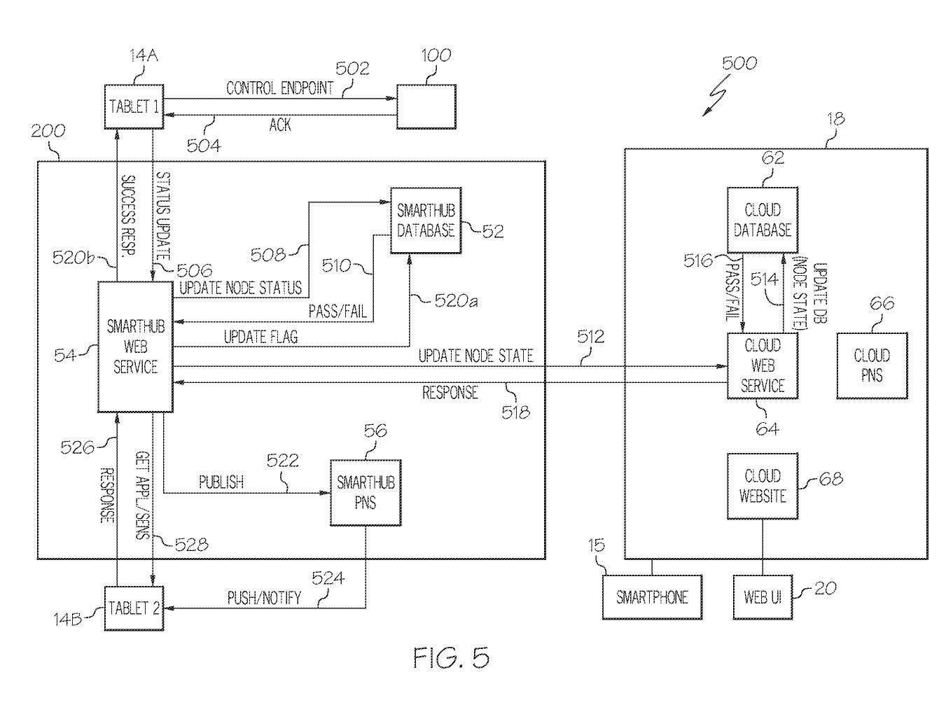

Hub 200 may also coordinate communications among all sensors 202 and switch panels 100 within a system 203 and with users connected through cloud 206. A security process including an authentication token may be employed by hub 200 to ensure that devices (for example switch panels or sensors) within one system 203 do not inadvertently communicate with devices or hubs 200 within another system 203. The community connection server 208 can be configured for providing functions to a plurality of buildings, for example, residents of a gated community. For example, the community connection server 208 can provide resident video calling, whereby residents can place video calls to each other via the network. In another example, the community connection server 208 may perform visitor screening, whereby building security can call residents to confirm the identity of visitors. In example embodiments in accordance with principles of inventive concepts, other features may include accounting, collaboration among buildings or units, complaint management, and/or reservations, for example. Components and the operation of hub 200 are explained in greater detail in the discussion related to FIG.5.

FIG. 5 is an illustration of data flow paths through an environment in which an example embodiment of a building automation system 500 in accordance with principles of inventive concepts is deployed. In this example embodiment, data flow paths illustrate the control of switch panel 100 by a tablet device 14A, 14B, or the like. In describing the data flow paths, reference may be made to elements of FIGS. 1-4. The communications exchanged in the data flow paths may comply with a messaging protocol, elements of which are described in the steps corresponding with the data flow paths.

The system 500 includes a first tablet 14A, a second tablet 14B, a switch panel 100, a hub 200 that communicate with each other via a cloud configuration 18. Other user devices such as a smartphone 15 and/or a web user interface 20 can also participate in the communication. In example embodiments tablets such as 14A and 14B may be, simply, local I/O associated with a switch panel 100, for example, with commands from and acknowledgements to tablets being commands from and acknowledgements to controller 309, for example. The first tablet 14A and/or the second tablet 14B can be wall-mounted or otherwise located in a manner that permits a user to control lights, fans, or other appliances from the tablet 14A, 14B.

The hub 200 provides a messaging interface between various elements of the system 500, for example, described herein. The hub 200 includes a database 52, a web service 54, and a push notification server (PNS) 56. One or more of the database 52, a web service 54, and the PNS 56 can be collocated under a single hardware platform, for example, a computer server, or separate from each other, and in communication with each other via the cloud configuration 18.

The PNS 56 outputs data related to user actions made on a device to the user's other configured devices. For example, the PNS 56 outputs data related to user actions in the event of any database 52 changes in the system, to the users other configured devices. Other devices, for example, another tablet, smartphone, desktop computer, etc., can subscribe to the PNS 56 module to receive the update. Other modules can request notifications in the event of any modifications in the database 52. A message can be sent from tablet 14 or other device to the PNS 56.

The database 52 can include well-known database software such as MySQL. The hub database 52 stores and tracks node status information, for example, for maintaining a record of all actions taken on different switch panels 100.

The cloud configuration 18 can be part of a network 16 and can include a database 62, a cloud web service 64, a cloud PNS 66, and/or a cloud website 68. One or more of the cloud database 62, cloud web service 64, cloud PNS 66, and cloud website 68 can be collocated under a single hardware platform, for example, a computer server, or separate from each other at the network 16, and in communication with each other via the network 16.

At step 502, a control message, for example, a Control_Endpoint message, is sent from the first tablet 14A to switch panel 100. In other embodiments, the Control_Endpoint message may be output directly by the hub 200. The control message includes commands or other data that is used to control one or more sensors, nodes, and/or endpoints related to electrical devices, for example, described herein. In an embodiment, a sensor module processes the control message to control one or more sensors. Such commands can be issued from the hub 200, a tablet, smartphone, or other electronic device, for example, a sensor alert event message described herein, which can be used by a sensor module to control a sensor. For example, the control message can indicate that a user turned on a light in communication with a node of a device. The switch panel 100 is coupled to one or more different appliances, permitting a user to control the appliances by a generated message such as the Control_Endpoint referred to herein. One or more sensors, which may be different than directly-connected appliances or external devices, can likewise be controlled by a generated message such as a Control_Endpoint message.

At step 504, the electronic device, or more specifically, the switch panel 100 (or controller 309), parses the message, controls a relay point 306 at the switch module 300 according to the message. The switch panel 100 outputs an acknowledgement (ACK) message to the first tablet 14A. Messages such as the ACK message can be generated and parsed at the controller 309.

At step 506, the first tablet 14A outputs a status update message to the smarthub web service 54. The status update message is used to provide the current status of the relay or regulated point, for example, at the switch module 300. The status update message can indicate to the hub 200 and/or tablet 14A if the device relay point/regulated point is switched ON/OFF, or what level of current is flowing through the point in the case of a regulator 308.

At step 508, the smarthub web service 54 outputs an update node state message to the smarthub database 52, which is updated with the latest status of the node. In example embodiments, each switch panel, which may be and endpoint, may include a plurality of nodes, each associated with an outlet. A sensor can also be construed as an endpoint, for example, an endpoint having a single node. The database 52 can include a record of actions taken with respect to different endpoints, or endpoint nodes (which may be, as previously described, outlets).

At step 510, hub database 52 sends a message, i.e., a pass/fail message, to the hub web service 54 informing the web server 54 whether the node status update is successful.

At step 512, the hub web service 54 may send an update node state message to a user account database at the cloud configuration 18. The update can include status information that is similar or the same as that exchanged between the smarthub web service 54 and the smarthub database 52.

At step 514, the cloud web service 64 outputs an update node state message to the cloud database 62, which is updated with the latest status of the node.

At step 516, the database 62 sends a message to the web service 64 informing the web service 64 whether the node status update is successful.

At step 518, the cloud web service 64 sends a response to the hub web service 54, providing a status of the node status update.

The hub PNS 52 may be constructed and arranged to notify other tablets, smartphones, or other user computers of any changes in the state of a device controlled by the system 500. Any and all tablet and smartphones that communicate with the system 500 register with the hub 200 for a push notification (updates) regarding different changes in the system 500. Accordingly, steps 520a, 520b, 522, 524, 526, and 528 relate to an exchange of messages and data for outputting a push notify update to different end user devices, for example, tablet 14B, in the system 500. Accordingly, if tablet 14B has the same user interface on the tablet screen, then the user interface of the tablet 14A will update automatically indicating the changed state, i.e., switched ON/OFF of the light appliance controlled by the system 500. On receiving the notify at step 524, the tablet 14B will also retrieve the latest information from the database to check if any other items have also changed in the system 500. Accordingly, a status or update made at one user interface, for example, at the touch panel, translates to an update on the other registered user interfaces, for example, at the smartphone, tablet, or computer web browser.

Steps similar to steps 522-528 can be performed between elements of the cloud configuration 18 and a remote smartphone 15 or other end user device having a user interface for updating the smartphone 15 or other end user device, and will not be repeated due to brevity.

Messages in steps 502 and 504 can be exchanged according to one transmission protocol, for example, transmission control protocol (TCP), while other steps, for example, messages in steps 506-528 can be exchanged according to another protocol, for example, hypertext transfer protocol (HTTP). In one or more steps, the web service can exchange messages or the like in TCP packets.

Accordingly, FIG. 5 illustrates how an switch panel 100 can be controlled by a tablet 14A and/or 14B. In other embodiments, the switch panel can be controlled by the smartphone 15, a web user interface (UI) at a home computer or the like, or other electronic device. The screen can also be displayed at a touch panel in communication with the touch circuit module described herein. One or more messages can be exchanged between the various elements of the system 500 that permits such devices to control the switch panel 100 in a similar manner.

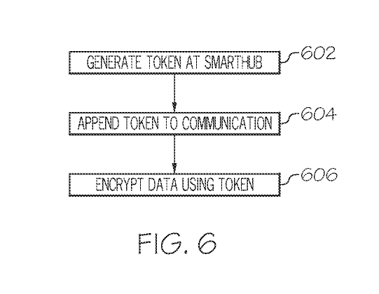

FIG. 6 is a method 600 for exchanging data in a building automation system, in accordance with an embodiment. When describing the method 600, reference is made to elements of FIGS. 1-5.

At step 602, a token is generated, for example, at a processor at a token generator 58 of the hub 200. In an embodiment, a token is generated according to the following equation: authToken=rand( )·id·time( ) wherein rand is a random number generator function, id is the id entry of the device in the database for which the authToken is being created, and time( ) refers to a time of day.

The token generation mechanism is used to generate a unique 32 bit code. The code is generated for every device in the network, for example, registered devices in communication with the smarthub and/or one or more switch panels 100. A token is used for communication with the device, for example, a token T1 can be the token for a first device. All other devices (e.g., smarthub, WEN, tablet) can use the same token T1 to send messages to the device.

A generated token can be used for a system level encryption of data. In an embodiment, a token is generated on a scheduled pre-determined basis, for example, every hour. In other embodiments, a token is generated each time an endpoint, for example, the switch panel 100, restarts or powers up, and sends a message to the hub 200 regarding its registration during power-up. In an embodiment, the token includes a 256 bit (32 byte) value.

At step 604, messages or other communications exchanged between the devices and the hub 200 can be appended along with the token. The messages are discarded by the devices and hub 200 if the correct AuthToken is not provided in the message. This permits an administrator or the like to protect the system from impostors, who can otherwise inject messages into the system to spoof different devices. Even if they find one authToken, they cannot take control of all the end points, since they numbers change for every startup or at a predetermined periodic rate. For example, an authentication token can be provided with a REGISTER message, for example, described herein.

At step 606, messages and other communications can be encrypted using the token. The token can be encrypted and/or decrypted according to a technique known to those of ordinary skill in the art.

The method 600 can prevent spurious commands from being injected into the system 500. An impostor will not be able to take control of the devices because each device uses a separate token. Even if the token is obtained by an impostor, the token will be modified in few hours and hence the imposter cannot get control of the device. This is required to ensure that no smart switch panel can be controlled by somebody who does not have valid credentials.

While the present inventive concepts have been particularly shown and described above with reference to exemplary embodiments thereof, it will be understood by those of ordinary skill in the art, that various changes in form and detail can be made without departing from the spirit and scope of the present inventive concepts described and defined by the following claims.

What is claimed is:

1. An electrical switching device, comprising:
a switching module including a plurality of switches for controlled connection between an electrical power source and a plurality of electrical outlets; and
a wireless electrical node including a controller to wirelessly receive a command and to respond to the command by controlling the state of the plurality of switches.

2. The electrical switching device of claim 1, wherein the wireless electrical node is connected to wirelessly provide switch status information.

3. The electrical switching device of claim 1, further comprising:
local input/output (I/O) for control and status of the plurality of switches.

4. The electrical switching device of claim 1, further comprising:
an interface for input from a sensor device.

5. The electrical switching device of claim 3, wherein the local I/O includes a touchscreen input.

6. The electrical switching device of claim 3, wherein the local I/O includes a graphical output display.

7. The electrical switching device of claim 1, further comprising a wireless interface for receiving from and transmitting to a portable wireless device.

8. The electrical switching device of claim 7, where the wireless interface is a WiFi interface.

9. The electrical switching device of claim 1, wherein the wireless node is responsive to proximal presence of an individual by reporting such presence via a wireless interface.

10. A wireless switching hub, comprising:
a wireless interface for communications with a wireless electrical switching device;
a web interface for communications with the World Wide Web; and
a controller responsive to commands received through the wireless interface by forwarding the commands to a wireless electrical switching device.

11. The wireless switching hub of claim 10, wherein the controller is responsive to a status message from the wireless electrical switching device by updating a status database.

12. The wireless switching hub of claim 10, wherein the controller is responsive to a status message from the wireless electrical switching device by transmitting the updated status to devices other than the wireless electrical switching device from which it received the status update.

13. The wireless switching hub of claim 10, wherein the hub is configured to provide status and control access to the wireless electrical switching device to wireless electronic devices through the world wide web.

14. The wireless hub of claim 10, wherein the hub is configured to generate a token for secure communications with other devices.

15. The wireless hub of claim 10, further comprising a push notification server to output the status of devices in communication with the hub.

16. A wireless switch control system, comprising:
a wireless electrical switching device including a switching module including:
a plurality of switches for controlled connection between an electrical power source and a plurality of electrical outlets; and
a wireless electrical node including a controller to wirelessly receive a command and to respond to the command by controlling the state of the plurality of switches; and
a wireless hub, including:
a wireless interface for communications with a wireless electrical switching device;
a web interface for communications with the World Wide Web; and
a controller responsive to commands received through the wireless interface by forwarding the commands to a wireless electrical switching device.

17. The wireless switch control system of claim 16, further comprising a sensor configured to communicate with the wireless hub.

18. The wireless switch control system of claim 17, wherein the sensor is chosen from among the group of: fire sensor, smoke sensor, intrusion sensor, or video sensor.

19. The wireless switch control system of claim 17, wherein the sensor is a video camera that is configured to send video information wirelessly to the hub and the hub is configured to forward the video information wirelessly.

20. The wireless switch control system of claim 16, wherein the hub is configured to generate a token for communications among devices within the system.
